(19) United States
(12) Patent Application Publication
(10) Pub. No.: US 2023/0267495 A1
(43) Pub. Date: Aug. 24, 2023

(54) LIQUIDITY POOLS FOR TOKENIZED REWARDS

(71) Applicant: Capital One Services, LLC, McLean, VA (US)

(72) Inventors: Xiaoguang Zhu, New York, NY (US); Kevin Osborn, Newton Highlands, MA (US); Samuel Rapowitz, Roswell, GA (US)

(21) Appl. No.: 17/678,937

(22) Filed: Feb. 23, 2022

(51) Int. Cl. G06Q 30/02; G06Q 20/38

(52) U.S. Cl. CPC G06Q 30/0228; G06Q 20/389

(57) ABSTRACT

Systems and methods for tokenizing reward points are disclosed. In particular, the systems and methods enable an issuer system to operate as a decentralized oracle to facilitate trading tokenized points and tokenized rewards in a blockchain environment. The system includes receiving transaction data indicative of a transaction completed at a transaction system, calculating a quantity of transaction points to allocate to the transaction data, and tokenizing the transaction points to create tokenized points. The tokenized points can be placed in a liquidity pool with tokenized rewards. The pair values between tokenized rewards and tokenized points can be assess by the issuer system accessing off-chain data and returning the pair values to the liquidity pool.

### FIELD

The present disclosure relates generally to systems and methods for tokenizing reward points and, more particularly, to an issuer system that operates as a decentralized oracle to facilitate trading tokenized points and tokenized rewards in a blockchain environment.

### BACKGROUND

One of the more enticing benefits of using credit cards issued by a financial institution is the ability to earn points based on spending. For example, most credit card issuers will offer a certain amount of points for each dollar spent on the line of credit, for example 2% of each dollar can be translated into points. These points are typically redeemable for a variety of different rewards, be it fiat currency, credits toward a credit card statement, or rewards via third-party vendors. These third-party vendor rewards can include rewards towards hotel stays, airline tickets, certain retail stores, and/or the like.

One limitation of prior reward-redemption programs is the illiquidity of the points, particularly when it comes to third-party vendor rewards. Ordinarily, the points are only valuable at vendors that have a contract with the credit card issuer. For example, the credit card issuer and vendor can agree to trade X amount of points for Y amount of rewards at the vendor. To illustrate using an example, the credit card issuer can contract with a hotel company such that 1000 credit card points can be exchanged for a reward of one-night stay at a hotel operated by the hotel company. This prior rewards system, however, provides the customer a limited number of redemption options, since adding new vendors means entering into new contracts, allocating a pair value between points and rewards, and updating the credit card issuer system to manage the rewards and contracts. These and other problems exist with current rewards systems.

### BRIEF SUMMARY OF THE INVENTION

Examples of the present disclosure provide solutions to the issues associated with illiquid rewards and points. The present disclosure describes systems and methods that enable a backend system to operate as a decentralized oracle to facilitate trading tokenized points and tokenized rewards in a blockchain environment. The present disclosure provides a method for tokenizing and quantifying reward points. The method can include receiving, for example at one or more processors associated with an issuer system, transaction data indicative of a transaction completed at a transaction system. The method can include calculating a quantity of transaction points to allocate to the transaction data. The method can include tokenizing the transaction points to create tokenized points. The method can include transmitting the tokenized points to a pool within a blockchain, the pool comprising tokenized rewards allocated to the pool by a plurality of vendor systems. The tokenized points can be tradeable with the tokenized rewards within the blockchain. The method can include accessing off-chain data comprising information related to transactions between the transaction points and off-chain rewards for the plurality of vendor systems and the transaction points. The method can include calculating pair values between the off-chain rewards and the transaction points based on the off-chain data. The method can include allocating the pair values to the tokenized rewards and the tokenized points within the pool.

Other aspects of the systems and methods described herein can include allocating particular multipliers to pair values between the off-chain rewards and the transaction points. These multipliers can increase the trading values of tokenized points for certain tokenized rewards. In some examples, the systems and methods can automatically make the trade between tokenized reward and tokenized points.

These and other aspects of the present disclosure are described in the Detailed Description below and the accompanying figures. Other aspects and features of examples of the present disclosure will become apparent to those of ordinary skill in the art upon reviewing the following description of specific, exemplary examples of the present invention in concert with the figures. While features of the present disclosure can be discussed relative to certain examples and figures, all examples of the present disclosure can include one or more of the features discussed herein. Further, while one or more examples can be discussed as having certain advantageous features, one or more of such features can also be used with the various examples of the invention discussed herein. In similar fashion, while exemplary examples can be discussed below as device, system, or method examples, it is to be understood that such exemplary examples can be implemented in various devices, systems, and methods of the present invention.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner. In the drawings:

FIG. 1 is a diagram of an example system environment that can be used to implement one or more examples of the present disclosure;

FIG. 2 is a component diagram of an example user device, according to the present disclosure;

FIG. 3 is a timing diagram of a method for tokenizing and quantifying reward points, according to the present disclosure;

FIG. 4 is a timing diagram of a method for trading points for rewards within the blockchain, according to the present disclosure;

FIG. 5 is a flowchart of an example process for tokenizing and quantifying reward points, according to the present disclosure; and

FIG. 6 is a flowchart of an example process for tokenizing and quantifying reward points, according to the present disclosure.

### DETAILED DESCRIPTION

Examples of the present disclosure generally include systems and methods for tokenizing reward points and, more particularly, to an issuer system that operates as a decentralized oracle to facilitate trading tokenized points and tokenized rewards in a blockchain environment. A decentralized oracle is a program or entity that sits between off-chain programs and on-chain data, and operates smart contracts to share information about the on-chain and off-chain data between nodes. A benefit of the present systems and methods is that the decentralized oracle can review transactions happening outside of the blockchain and relay that information back to the blockchain to facilitate trades. To illustrate, without using a decentralized oracle, it is difficult to trade one asset for another in a blockchain environment. Use of tools such as application programming interfaces (APIs) are of little help in this regard. For example, consider that person A with commodity A is trying to make a trade with person B for commodity B. Both person A and person B can call respective APIs to get a pair value between commodity A and commodity B. But since the value of the commodity can change at any moment, if the APIs are not called at the same exact time, the two APIs may not agree on the pair value between the two commodities. The trade, therefore, cannot be facilitated with a precise pair value using APIs.

Referring again to a decentralized oracle, the oracle provides a solution to the consensus issue described above. As will be appreciated, one benefit of blockchain is the decentralized nature of the environment. The oracle described herein is able to leverage information outside of the blockchain technology and relay the information back to the blockchain so that transactions can be completed. The oracle can act as another node in the blockchain that can independently complete transactions (e.g., pair-value research), meaning that the other nodes (e.g., individual user devices trading on the blockchain) can rely on the information to come to a deterministic value for the traded pairs. In this regard, the solutions described herein are necessarily rooted in computer technology as they relate to using a specific entity that can access, compile, and calculate data for blockchain trades.

Another benefit the present systems and methods provide to rewards programs is the ability to use a liquidity pool to manage assets (e.g., points and rewards) in the blockchain environment. Unlike prior systems that required a credit card issuer (otherwise referred to herein as merely the “issuer”) to enter into contracts with vendors, continuously negotiate the pair value for the points and/or rewards, and maintain a database for this information, the present systems and methods rely upon the ability of blockchains to be managed by a plurality of different nodes. For example, the processing and data storage requirements of the issuer system (e.g., a backend system for the issuer) are decreased because the processing load of maintaining the data on the blockchain is shared by all nodes. The other nodes can include customer computers and/or backend systems associated with vendors wishing to place rewards into the system for trading. Further, the present systems and methods provide what is referred to herein as a liquidity pool for any vendor to add rewards to the pool. In this manner, any vendor can submit rewards into the pool to be held for trade with customer points. The issuer system and/or liquidity pool can hold tokenized assets (e.g., tokenized rewards) in escrow until they are traded for tokenized points.

Reference will now be made in detail to exemplary examples of the disclosed technology, examples of which are illustrated in the accompanying drawings and disclosed herein. Wherever convenient, the same reference numbers will be used throughout the drawings to refer to the same or like parts.

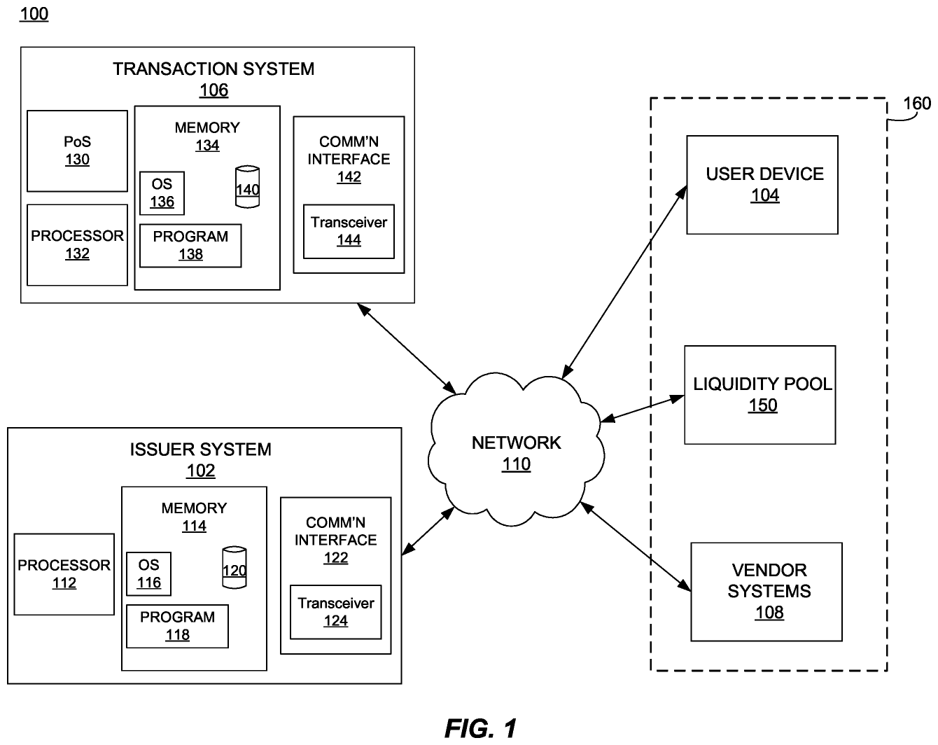

FIG. 1 is a diagram of an example system environment 100 environment that can be used to implement one or more examples of the present disclosure. A more detailed explanation of the components of the system environment 100 is provided below. It is beneficial, however, to provide a brief overview to describe the components of the systems and methods for tokenizing rewards and points. The system environment 100 can include an issuer system 102. The issuer system 102 can be associated with a financial institution that issues a credit card, manages customer accounts, and provides points for transactions completed with the credit card or line of credit. As described above, it is contemplated that the issuer system described herein can access off-chain data including information related to transactions between (i) transaction points for credit-card transactions and (ii) off-chain vendor rewards. To this end, the issuer system 102 can operate as a decentralized oracle to manage valuation and trading of tokenized points and tokenized rewards within a pool (e.g., liquidity pool 150). It will be understood, however, that when reference is made herein to the issuer system 102 completing a task or process, another entity can equally perform the task or processes for the issuer system 102. For example, the issuer system 102 can request third parties to facilitate the management of the liquidity pool 150 and/or operate as the decentralized oracle.

The issuer system can communicate over a network 110 with a transaction system 106. The transaction system can be associated with entities that provide goods or services for a fee. The customer can, for example, complete a transaction at the transaction system 106 (e.g., at a point of sale (PoS) device), and the transaction information can be relayed to the issuer system 102 for processing. After processing the transaction, the issuer system 102 can allocate a number of points to the particular transaction.

The system environment 100 can also include a user device 104. The user device 104 can be a component, or a node, of a blockchain 160. As will be appreciated, the blockchain 160 can comprise a plurality of nodes. Other nodes within the blockchain 160 environment can include one or more vendor system 108 that offer rewards to be traded within the blockchain 160. For example, a vendor system 108 can include any entity that wishes to add rewards to be traded for points, including but not limited to hotels, airlines, car rental entities, or any other retail or service provider (e.g., rewards can work similar to a gift card in that the rewards can be used in lieu of fiat currency).

The blockchain 160 can also include a liquidity pool 150. As described above, the liquidity pool can be the repository of the points and/or rewards that can be traded in the system. The liquidity pool 150 can be data represented within one or more addresses associated with the assets (e.g., points or rewards). Addresses comprise the final location of particular assets and asset information. For example, an address can include a particular amount of points, a particular amount of rewards, etc. The components or nodes of the blockchain 160 can communicate with the issuer system 102 over a wired or wireless network 110. The network 110 can, therefore, facilitate transactions being made in the blockchain 160 (e.g., trades in points, rewards, etc.) between the nodes.

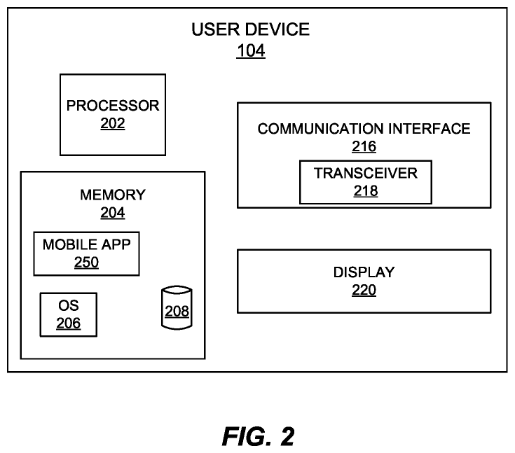

FIG. 2 is a component diagram of an example user device 104, according to the present disclosure. The device 104 can be a mobile computing device (e.g., a smart phone, tablet computer, smart wearable (e.g., a smart watch), portable laptop computer, voice command device, wearable augmented reality device, or other mobile computing device) or a stationary device (e.g., desktop computer). The device 104 can include a processor 202 and a memory 204, operating system (“OS”) 206, one or more programs (e.g., a mobile application 250), and/or data storage 208. The device 104 can also include a communication interface 216 that includes a transceiver 218. The communication interface 216 and/or transceiver 218 can be used to transmit and/or receive the data described throughout this disclosure, including for example the requests to select one or more tokenized rewards to trade for tokenized points. The device 104 can include a display 220. The display 220 can provide visual representation of the applications (e.g., mobile application 250) and/or graphical user interfaces (GUIs) associated with those applications.

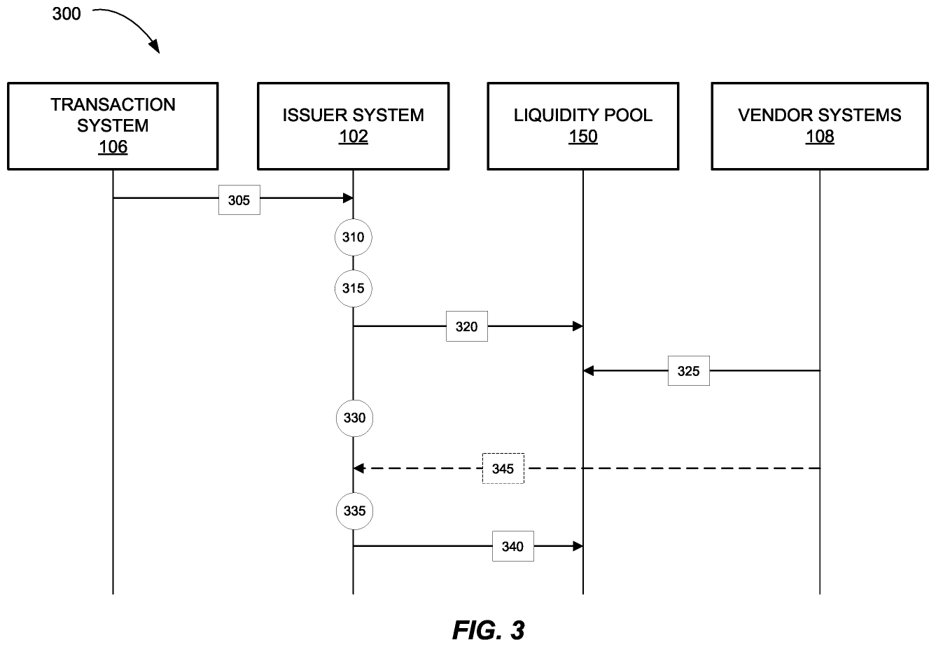

FIG. 3 is a timing diagram of a method 300 for tokenizing and quantifying reward points, according to the present disclosure. The method 300 described in the timing diagram can include components and/or entities described herein, including the transaction system 106, the issuer system 102, the liquidity pool 150 (within the blockchain 160 environment), and one or more vendor systems 108. Method 300 can begin at block 305, where the issuer system receives transaction data indicative of a transaction completed at a transaction system 106. The transaction, for example, can be completed at a PoS device 130 which can be in communication with one or more processors (e.g., processor 112) of the issuer system 102. This transaction can be completed with a device that enables purchases via an account associated with the issuer system 102. For example, the transaction can be completed with a credit card, a smart device with contactless payment technology, and the like.

At block 310, the issuer system 102 can calculate a quantity of transaction points to allocate to the transaction data. To illustrate using an example, the issuer system 102 may provide a certain quantity of points per dollar spent, for example 100 points for each dollar ($1.00) spent on the line of credit with the financial institution. These points can be used to trade with rewards that are roughly worth 100 points. A description of what 100 points may be worth in terms of vendor points is discussed in greater detail below. In other examples, the points can be calculated as a representation of fiat currency. For example, the financial institution may provide 3% back on each dollar ($1.00) spent, meaning that a $100 credit-card purchase can equal $3.00 worth in points. Again, how much trading power this $3.00 in points is worth with respect to vendor rewards can be calculated by the issuer system 102, as described below.

At block 315, the issuer system 102 can tokenize the transaction points associated with the transaction to create tokenized points. As will be appreciated, tokenization of data involves the process of trading one set of data for another. Tokenized data is undecipherable and, typically, irreversible data that represents more sensitive data. To illustrate, if the customer received $3.00 worth of points from the transaction, the issuer system 102 can create a new set of data for the blockchain 160 that includes a representation of $3.00 worth of points, valued at the time the tokenized data was created.

At block 320, the issuer system can transmit the tokenized points to a pool (e.g., liquidity pool 150) within the blockchain 160. The liquidity pool 150 can also include tokenized rewards allocated to the liquidity pool 150 by a plurality of vendor systems 108. For example, at block 325, the issuer system 102 can receive rewards from one or more vendor systems 108 and tokenize the rewards for storage in the liquidity pool 150. To illustrate using an example, the vendor systems 108 can include a hotel chain that wishes to provide hotel points to the liquidity pool 150, an airline that would like to provide airline travel points to the liquidity pool 150, and/or a retailer wishing to provide rewards such that the customers can shop at the retailer's stores. The hotel chain, airline, and retailer all may like to work with the financial institution associated with the issuer system 102 to incentivize the customers of the issuer to use their products or services. To this end, each of those entities can be freely able to upload rewards into the liquidity pool 150. This can be completed by first tokenizing the rewards, which can be completed by the issuer system 102 in a step similar to that described for block 315. Enabling all vendors to provide rewards for trading is one advantage of the present system over prior systems. The systems described herein do not require a contract to be made between the vendors and the issuer. Instead, the system relies on smart contracts native to the blockchain 160 environment. Smart contracts are programs stored on a blockchain that run when conditions are met. These smart contracts can be used to automate the execution of a particular intended outcome—e.g., if the value of this particular reward is W, then it can be traded for X points; if a customer requests Y rewards and has Z points, the transaction can be completed if Y rewards costs Z points. So any vendor that wishes to participate in this point and reward trading can upload rewards into the liquidity pool 150.

At block 330, the issuer system 102 can access off-chain data comprising information related to transactions between the transaction points and off-chain rewards points for the plurality of vendor systems and the transaction points. This step shows how the issuer system 102 can act as the decentralized oracle described above. Without any other information to allocate pair values between X points and Y rewards, the smart contracts may be unable to complete a transaction at a defined value. The off-chain data accessed by the issuer system 102 can include any transaction data that is public or otherwise available to the transaction system. In some examples, the off-chain data can include data for traditional, non-blockchain rewards programs. To illustrate, a financial institution can have a traditional system for rewards points, where customers complete transactions, receive points, and trade those points for certain rewards within a non-blockchain, traditional ecosystem provided by the financial institution (e.g., issuer system 102) for redeeming points for rewards. This information can provide the valuation necessary for the issuer system 102, which can act as a decentralized oracle, to return pair values to the blockchain 160. If 100 off-chain points counts for one (1) airline mile for a particular airline, for example, that 100:1 pair value between off-chain points and off-chain rewards can be used to determine on-chain valuation of tokenized points and tokenized airline rewards. The issuer system 102 can also access other off-chain data to determine pair values. For example, the system can access off-chain, online retailers to determine how much certain retail rewards are worth. If a retailer is offering 5% rebates on gift card purchases of $100 or more, for example, the issuer system 102 can know to allocate $200 retailer rewards for $190 worth of transaction points. This pair-value information for the retailer can be returned to the blockchain 160.

It is contemplated that the issuer system 102 can access the off-chain data periodically based on a predetermined period of time. For example, the issuer system 102 can access its non-blockchain rewards system every hour, every day, every week, etc., depending on how current the issuer system 102 wishes to update the blockchain pair values. Similarly, the issuer system 102 can access third-party databases and websites, for example using a web crawler, to identify off-chain pair values for other types of rewards on a periodic basis.

At block 335, the issuer system 102 can calculate pair values between the off-chain vendor rewards and the transaction points based on the off-chain data. At block 340, the issuer system can allocate the pair values to the tokenized rewards and the tokenized points within the pool. At this point, the trades between tokenized rewards and tokenized points can be made by the smart contract(s), since the information related to valuation is present within the blockchain 160. In some embodiments, the issuer system 102 can calculate pair values from the data accessed in block 330. In other scenarios, the pair values can be adjusted based on other input. In some examples and as shown in block 345, the issuer system 102 can receive off-chain multiplier data from a first vendor system of the plurality of vendor systems 108. The pair values described in block 335 can be adjusted based on the off-chain multiplier data. This multiplier data can include certain promotions that one or more vendors associated with the vendor system 108 wish to include to entice customers to trade for their tokenized rewards. For example, a vendor system 108 can communicate with the issuer system 102 to inform the system that the vendor wishes to increase the value of their tokenized rewards. If the issuer system 102 calculates in block 335 that vendor X has off-chain rewards that trade at 100 rewards per 100 points, vendor X may wish to, instead, trade at 150 rewards per 100 points. Vendor X can inform issuer system 102 of this multiplier (i.e., 1.5X the original assessed pair value in this example), and the issuer system 102 can allocate that updated pair value to that particular reward in the liquidity pool 150.

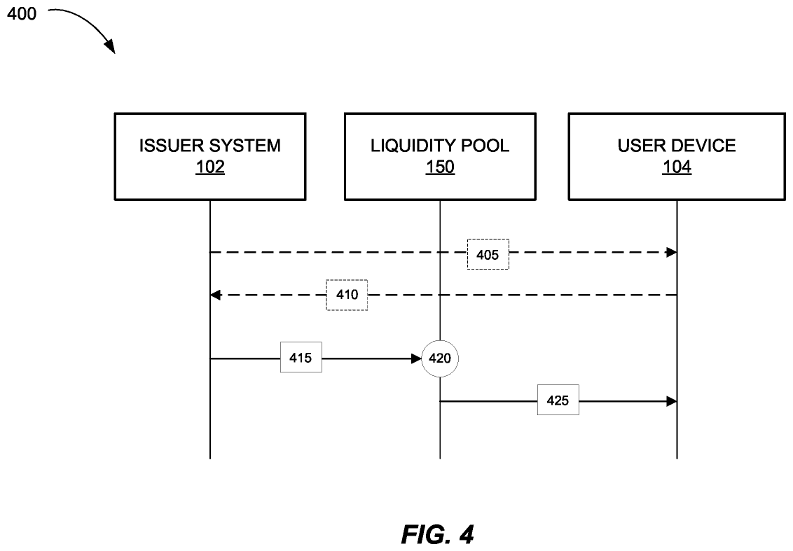

FIG. 4 is a timing diagram of a method 400 for trading points for rewards within the blockchain, according to the present disclosure. At block 405, the issuer system 102 can transmit (e.g., via the transceiver 124 and processor 112) a notification to a user device 104. The notification can include data indicative of the pair values, and the notification can seek a selection of a first set of the tokenized rewards associated with a first vendor system of the plurality of vendor systems 108. At block 410, the issuer system 102 can receive a request from the user device 104 selecting the first set of the tokenized rewards from a plurality of points within the liquidity pool 150. In block 415, the issuer system 102 can access the liquidity pool 150 with information about the pair values. In block 420, the issuer system 102 can facilitate the trade of the tokenized points for the first set of the tokenized rewards in response to receiving the request. At block 425, the user device 104 can receive from the liquidity pool 150 the first set of tokenized rewards to a digital wallet, e.g., a mobile application 250 operating on the user device 104.

The steps described above in blocks 405-425 were described with reference to a system wherein the user device 104 requests which tokenized rewards the user wishes to trade for tokenized points. However, other examples enable the system to automatically trade points and rewards when conditions are met, e.g., via smart contract. For example, step 420 can include automatically trading the tokenized points for a first set of tokenized rewards based on the pair values and via smart contract. If the issuer system 102 finds that reward X is trading at a preferred rate off-chain, as in the purchasing power of credit-card points are high at that particular instant, the system can proceed to facilitate an automatic trade.

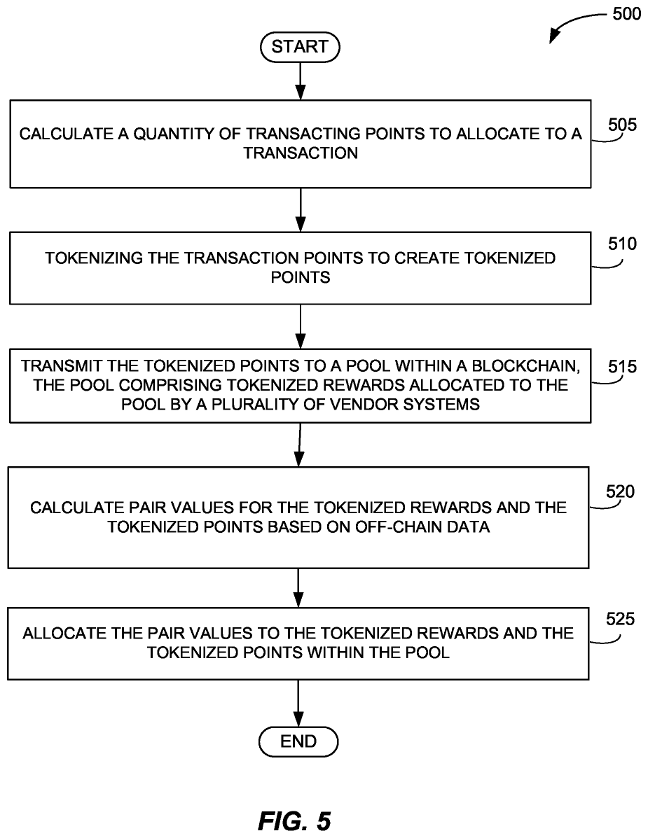

FIG. 5 is a flowchart of an example process 500 for tokenizing and quantifying reward points, according to the present disclosure. Process 500 can be performed in whole or in part by the components of the issuer system 102, for example processor 112, memory 114, operating system (“OS”), the transceiver 144, etc. Process 500 can include calculating 505 a quantity of transacting points to allocate to a transaction. Process 500 can include tokenizing 510 the transaction points to create tokenized points. Process 500 can include transmitting 515 the tokenized points to a pool (e.g., liquidity pool 150) within a blockchain (e.g., blockchain 160). The pool can include tokenized rewards allocated to the pool by a plurality of vendor systems (e.g., vendor system(s) 108). The tokenized points can be tradeable with the tokenized rewards within the blockchain 160. Process 500 can include calculating 520 pair values for the tokenized rewards and the tokenized points based on off-chain data. The pair values can be identified and calculated as described above with reference to method 300 in FIG. 3. Process 500 can include allocating 525 the pair values to the tokenized rewards and the tokenized points within the pool.

Process 500 can end after the allocating 525 step, or other method steps can be included. For example, issuer system 102 can use multiplier data as described above to calculate pair values. In some examples, the issuer system 102 can automatically trade the tokenized points for tokenized rewards; in some examples, the issuer system 102 can receive feedback from the user device 104 to determine which trades should be made.

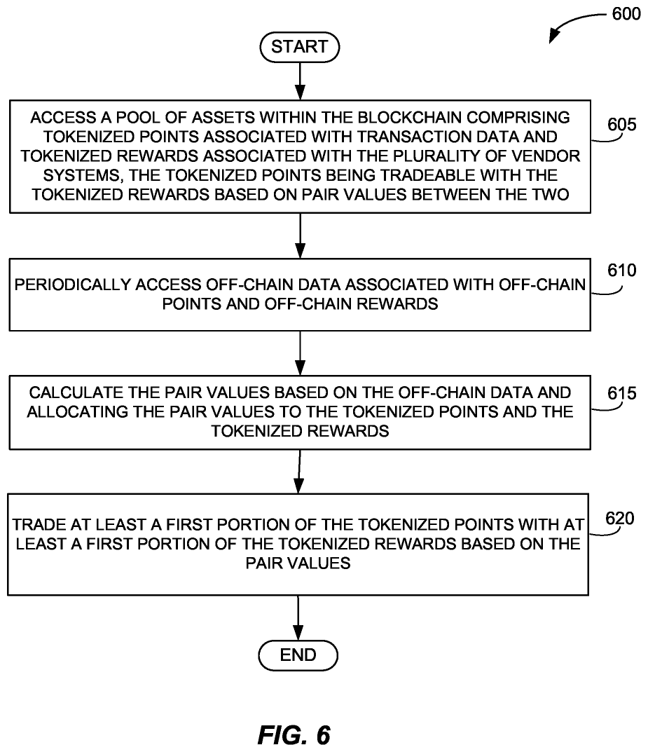

FIG. 6 is a flowchart of an example process 600 for tokenizing and quantifying reward points, according to the present disclosure. Process 600 can be performed in whole or in part by the components of the issuer system 102, for example processor 112, memory 114, operating system (“OS”), the transceiver 144, and the like. Process 600 can include accessing 605 a pool of assets within the blockchain (e.g., blockchain 160) comprising tokenized points associated with transaction data and tokenized rewards associated with the plurality of vendor systems (e.g., vendor systems 108). The tokenized points can be tradeable with the tokenized rewards based on pair values between the two. Process 600 can include periodically accessing 610 off-chain data associated with off-chain points and off-chain rewards. Process 600 can include calculating 615 the pair values based on the off-chain data and allocating the pair values to the tokenized points and the tokenized rewards. Process 600 can include trading 620 at least a first portion of the tokenized points with at least a first portion of the tokenized rewards based on the pair values. As stated above, process 600 follows that the issuer system operates as a decentralized oracle to manage valuation and trading of the tokenized points and the tokenized rewards within the pool.

Referring again to the system environment 100 described in FIG. 1, the issuer system 102 can include one or more processors 112, a memory 114, and data storage, for example in database 120. The processor 112 can include one or more of a microprocessor, microcontroller, digital signal processor, co-processor or the like or combinations thereof capable of executing stored instructions and operating upon stored data.

The memory 114 of the issuer system 102 can include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data.

The memory 114 of the issuer system 102 can contain an operating system (“OS”) 116 that can run one or more programs 118. The one or more programs 118 can perform one or more functions of the disclosed examples. The one or more programs 118 can include, for example, a program for accessing off-chain data and allocating pair values to the tokenized rewards and tokenized points. The memory 114 can also include any combination of one or more databases, including for example database 120, controlled by memory controller devices (e.g., server(s), etc.) or software, such as document management systems, Microsoft® SQL databases, SharePoint® databases, Oracle® databases, Sybase® databases, or other relational databases.

The issuer system 102 can include a communication interface 122 for communicating with external systems or internal systems. The communication interface 122 can include a serial port, a parallel port, a general-purpose input and output (GPIO) port, a game port, a universal serial bus (USB), a micro-USB port, a high definition multimedia (HDMI) port, a video port, an audio port, a Bluetooth™ port, an NFC port, another like communication interface, or any combination thereof. The communication interface 122 can include a transceiver 124 to communicate with compatible devices, for example via short range, long range (e.g., cellular, local area networks (LAN), wide area networks (WAN), etc.), or similar technologies that enables the issuer system 102 to communicate via the network 110 described herein.

The transaction system 106 can include similar components as described for the issuer system 102. For example, the transaction system 106 can include a processor 132, memory 134, an OS 136, one or more programs 138, and data storage via a database 140, which can be similar to processor 112, memory 114, OS 116, program 118, and database 120, respectively. Further, the transaction system 106 can include a PoS device 130. The PoS device 130 can be an electronic fund transfer terminal that accepts payments via a credit card via a magnetic stripe and/or via contactless payment. The PoS device 130 can also be a backend system that receives transaction requests from a customer and transfers information to the issuer system 102, for example a backend system for an online retailer.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described in this disclosure as making up various elements of the systems and methods are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Examples of the present disclosure can be implemented according to at least the following clauses:

Clause 1: A method for tokenizing and quantifying reward points, the method comprising: receiving, at one or more processors associated with an issuer system, transaction data indicative of a transaction completed at a transaction system; calculating, by the one or more processors, a quantity of transaction points to allocate to the transaction data; tokenizing, by the one or more processors, the transaction points to create tokenized points; transmitting, from the one or more processors, the tokenized points to a pool within a blockchain, the pool comprising tokenized rewards allocated to the pool by a plurality of vendor systems, the tokenized points being tradeable with the tokenized rewards within the blockchain; accessing, by the one or more processors, off-chain data comprising information related to transactions between the transaction points and off-chain rewards for the plurality of vendor systems and the transaction points; calculating, by the one or more processors, pair values between the off-chain rewards and the transaction points based on the off-chain data; and allocating, by the one or more processors, the pair values to the tokenized rewards and the tokenized points within the pool.

Clause 2: The method of Clause 1 further comprising: automatically trading, by the one or more processors, the tokenized points for a first set of tokenized rewards based on the pair values and via smart contract; and transferring, by the one or more processors in communication with the blockchain, the first set of tokenized rewards to a digital wallet.

Clause 3: The method of Clause 2 further comprising, receiving, at the one or more processors, off-chain multiplier data from a first vendor system of the plurality of vendor systems, wherein the pair values are adjusted based on the off-chain multiplier data.

Clause 4: The method of Clause 3, wherein the first set of tokenized rewards are associated with the first vendor system.

Clause 5: The method of any of Clauses 1 to 4, wherein the pair values are adjusted based on off-chain multipliers provided to the issuer system by the plurality of vendor systems, and the method further comprises: automatically trading, by the one or more processors, the tokenized points for a first set of tokenized rewards based on the pair values adjusted by the off-chain multipliers.

Clause 6: The method of any of Clauses 1 to 5, wherein the pool provides open access to any vendor systems allocating rewards to the pool.

Clause 7: The method of any of Clauses 1 to 6 further comprising: transmitting, from the one or more processors, a notification to a user device, the notification comprising data indicative of the pair values and seeking a selection of a first set of the tokenized rewards associated with a first vendor system of the plurality of vendor systems; receiving, at the one or more processors, a request from the user device selecting the first set of the tokenized rewards; trading, by the one or more processors, the tokenized points for the first set of the tokenized rewards in response to receiving the request; and transferring, by the one or more processors in communication with the blockchain, the first set of tokenized rewards to a digital wallet.

Clause 8: The method of Clause 7, wherein the notification comprises data indicative of an off-chain multiplier data from the first vendor system.

Clause 9: The method of any of Clauses 1 to 8, wherein the one or more processors access the off-chain data periodically based on a predetermined period of time.

Clause 10: The method of any of Clauses 1 to 9, wherein the plurality of vendor systems and a plurality of user devices are nodes in the blockchain.

Clause 11: A system for tokenizing and quantifying reward points, the system comprising: one or more processors; and memory storing instructions that, when executed by the one or more processors, cause the system to: calculate a quantity of transacting points to allocate to a transaction; tokenize the transaction points to create tokenized points; transmit the tokenized points to a pool within a blockchain, the pool comprising tokenized rewards allocated to the pool by a plurality of vendor systems, the tokenized points being tradeable with the tokenized rewards within the blockchain; calculate pair values for the tokenized rewards and the tokenized points based on off-chain data; and allocate the pair values to the tokenized rewards and the tokenized points within the pool.

Clause 12: The system of Clause 11, wherein the off-chain data comprises trading data between off-chain transaction points and off-chain rewards.

Clause 13: The system of Clause 11 or 12, wherein the instructions, when executed by the one or more processors, cause the system to: trade the tokenized points for a first set of tokenized rewards based on the pair values; and transfer the first set of tokenized rewards to a digital wallet.

Clause 14: The system of Clause 13, wherein the off-chain data includes multiplier data from a first vendor system of the plurality of vendor systems, wherein the pair values are adjusted based on the multiplier data.

Clause 15: The system of Clause 14, wherein the first set of tokenized rewards are associated with the first vendor system.

Clause 16: The system of any of Clauses 11 to 15, wherein the pair values are adjusted based on off-chain multipliers provided to the system by the plurality of vendor systems, and wherein the instructions, when executed by the one or more processors, cause the system to automatically trade the tokenized points for a first set of tokenized rewards based on the pair values adjusted by the off-chain multipliers.

Clause 17: The system of any of Clauses 11 to 16, wherein the instructions, when executed by the one or more processors, cause the system to: transmit a notification to a user device, the notification comprising data indicative of the pair values and seeking a selection of a first set of the tokenized rewards associated with a first vendor system of the plurality of vendor systems; receive a request from the user device selecting the first set of the tokenized rewards; trade the tokenized points for the first set of tokenized rewards in response to receiving the request; and transfer the first set of the tokenized rewards to a digital wallet.

Clause 18: The system of any of Clauses 11 to 17, wherein the system accesses the off-chain data periodically based on a predetermined period of time and calculates the pair values upon accessing the off-chain data.

Clause 19: A system for tokenizing and quantifying reward points, the system comprising: one or more processors in communication with nodes of a blockchain, the nodes comprising one or more user devices and a plurality of vendor systems; memory storing instructions that, when executed by the one or more processors, cause the system to: access a pool of assets within the blockchain comprising tokenized points associated with transaction data and tokenized rewards associated with the plurality of vendor systems, the tokenized points being tradeable with the tokenized rewards based on pair values between the two; periodically access off-chain data associated with off-chain points and off-chain rewards; calculate the pair values based on the off-chain data and allocating the pair values to the tokenized points and the tokenized rewards; and trade at least a first portion of the tokenized points with at least a first portion of the tokenized rewards based on the pair values, wherein the one or more processors are associated with an issuer system, and wherein the issuer system operates as a decentralized oracle to manage valuation and trading of the tokenized points and the tokenized rewards within the pool.

Clause 20: The system of Clause 19, wherein the instructions, when executed by the one or more processors, cause the system to receive off-chain multiplier data from a first vendor system of the plurality of vendor systems, wherein the pair values are adjusted based on the off-chain multiplier data, and wherein the first portion of the tokenized rewards are associated with the first vendor system.

### Exemplary Use Cases

The following exemplary use cases describe examples of a typical user flow pattern. They are intended solely for explanatory purposes and not limitation.

National Bank decides they will implement a program that enables customers and vendors to trade credit-card points for rewards over a blockchain environment. To do so, National Bank provides addresses for customers and vendors alike to compile points and rewards in a liquidity pool in the blockchain. Hotel Chain Inc. wishes to participate in the program. Hotel Chain has never before worked with National Bank in a rewards program, but the new blockchain environment does not require them to enter into contracts with National Bank. All they are required to do is to pool rewards into the liquidity pool so that users can choose to trade with Hotel Chain.

Every two days, National Bank performs a pair-value check of all rewards in the liquidity pool. Using a web crawler, National Bank identifies that Hotel Chain works with Regional Bank in that bank's rewards program. Further, it identifies that for every on Regional Bank's credit card, customers receive $30 worth of Hotel Chain rewards. National Bank takes this information and feeds it into the smart contracts within the liquidity pool. Tim, a National Bank customer who is signed up for crypto-rewards at National Bank, decides to exchange his 20,000 National Bank rewards (which are equivalent to spending approximately $1500 with his National Bank credit card) for $45 worth of Hotel Chain rewards. National Bank's backend system facilitates the trade. After the trade, National Bank contacts Hotel Chain to transfer $45 to compensate for their rewards.

What is claimed is:

1. A method for tokenizing and quantifying reward points, the method comprising:
receiving, at one or more processors associated with an issuer system, transaction data indicative of a transaction completed at a transaction system;
calculating, by the one or more processors, a quantity of transaction points to allocate to the transaction data;
tokenizing, by the one or more processors, the transaction points to create tokenized points;
transmitting, from the one or more processors, the tokenized points to a pool within a blockchain, the pool comprising tokenized rewards allocated to the pool by a plurality of vendor systems, the tokenized points being tradeable with the tokenized rewards within the blockchain;
accessing, by the one or more processors, off-chain data comprising information related to transactions between the transaction points and off-chain rewards for the plurality of vendor systems and the transaction points;
calculating, by the one or more processors, pair values between the off-chain rewards and the transaction points based on the off-chain data; and
allocating, by the one or more processors, the pair values to the tokenized rewards and the tokenized points within the pool.

2. The method of claim 1 further comprising:
automatically trading, by the one or more processors, the tokenized points for a first set of tokenized rewards based on the pair values and via smart contract; and
transferring, by the one or more processors in communication with the blockchain, the first set of tokenized rewards to a digital wallet.

3. The method of claim 2 further comprising, receiving, at the one or more processors, off-chain multiplier data from a first vendor system of the plurality of vendor systems, wherein the pair values are adjusted based on the off-chain multiplier data.

4. The method of claim 3, wherein the first set of tokenized rewards are associated with the first vendor system.

5. The method of claim 1, wherein the pair values are adjusted based on off-chain multipliers provided to the issuer system by the plurality of vendor systems, and the method further comprises:
automatically trading, by the one or more processors, the tokenized points for a first set of tokenized rewards based on the pair values adjusted by the off-chain multipliers.

6. The method of claim 1, wherein the pool provides open access to any vendor systems allocating rewards to the pool.

7. The method of claim 1 further comprising:
transmitting, from the one or more processors, a notification to a user device, the notification comprising data indicative of the pair values and seeking a selection of a first set of the tokenized rewards associated with a first vendor system of the plurality of vendor systems;
receiving, at the one or more processors, a request from the user device selecting the first set of the tokenized rewards;
trading, by the one or more processors, the tokenized points for the first set of the tokenized rewards in response to receiving the request; and
transferring, by the one or more processors in communication with the blockchain, the first set of tokenized rewards to a digital wallet.

8. The method of claim 7, wherein the notification comprises data indicative of an off-chain multiplier data from the first vendor system.

9. The method of claim 1, wherein the one or more processors access the off-chain data periodically based on a predetermined period of time.

10. The method of claim 1, wherein the plurality of vendor systems and a plurality of user devices are nodes in the blockchain.

11. A system for tokenizing and quantifying reward points, the system comprising:
one or more processors; and
memory storing instructions that, when executed by the one or more processors, cause the system to:
calculate a quantity of transacting points to allocate to a transaction;
tokenize the transaction points to create tokenized points;
transmit the tokenized points to a pool within a blockchain, the pool comprising tokenized rewards allocated to the pool by a plurality of vendor systems, the tokenized points being tradeable with the tokenized rewards within the blockchain;
calculate pair values for the tokenized rewards and the tokenized points based on off-chain data; and
allocate the pair values to the tokenized rewards and the tokenized points within the pool.

12. The system of claim 11, wherein the off-chain data comprises trading data between off-chain transaction points and off-chain rewards.

13. The system of claim 11, wherein the instructions, when executed by the one or more processors, cause the system to:
trade the tokenized points for a first set of tokenized rewards based on the pair values; and
transfer the first set of tokenized rewards to a digital wallet.

14. The system of claim 13, wherein the off-chain data includes multiplier data from a first vendor system of the plurality of vendor systems, wherein the pair values are adjusted based on the multiplier data.

15. The system of claim 14, wherein the first set of tokenized rewards are associated with the first vendor system.

16. The system of claim 11, wherein the pair values are adjusted based on off-chain multipliers provided to the system by the plurality of vendor systems, and wherein the instructions, when executed by the one or more processors, cause the system to automatically trade the tokenized points for a first set of tokenized rewards based on the pair values adjusted by the off-chain multipliers.

17. The system of claim 11, wherein the instructions, when executed by the one or more processors, cause the system to:
transmit a notification to a user device, the notification comprising data indicative of the pair values and seeking a selection of a first set of the tokenized rewards associated with a first vendor system of the plurality of vendor systems;
receive a request from the user device selecting the first set of the tokenized rewards;
trade the tokenized points for the first set of tokenized rewards in response to receiving the request; and
transfer the first set of the tokenized rewards to a digital wallet.

18. The system of claim 11, wherein the system accesses the off-chain data periodically based on a predetermined period of time and calculates the pair values upon accessing the off-chain data.

19. A system for tokenizing and quantifying reward points, the system comprising:
one or more processors in communication with nodes of a blockchain, the nodes comprising one or more user devices and a plurality of vendor systems;
memory storing instructions that, when executed by the one or more processors, cause the system to:
access a pool of assets within the blockchain comprising tokenized points associated with transaction data and tokenized rewards associated with the plurality of vendor systems, the tokenized points being tradeable with the tokenized rewards based on pair values between the two;
periodically access off-chain data associated with off-chain points and off-chain rewards;
calculate the pair values based on the off-chain data and allocating the pair values to the tokenized points and the tokenized rewards; and
trade at least a first portion of the tokenized points with at least a first portion of the tokenized rewards based on the pair values,
wherein the one or more processors are associated with an issuer system, and
wherein the issuer system operates as a decentralized oracle to manage valuation and trading of the tokenized points and the tokenized rewards within the pool.

20. The system of claim 19, wherein the instructions, when executed by the one or more processors, cause the system to receive off-chain multiplier data from a first vendor system of the plurality of vendor systems, wherein the pair values are adjusted based on the off-chain multiplier data, and wherein the first portion of the tokenized rewards are associated with the first vendor system.
